(19) United States
(12) Patent Application Publication
(10) Pub. No.: US 2022/0334067 A1
(43) Pub. Date: Oct. 20, 2022

(54) DEVICE FOR MEASURING COMPONENTS OF A PIPE PRIOR TO WELDING

(71) Applicant: GRTGAZ, BOIS-COLOMBES Cedex (FR)

(72) Inventors: Pascal AUSSANT, Cergy-le-Haut (FR); Dominique GUEUGNAUT, Paris (FR)

(21) Appl. No.: 17/753,665

(22) PCT Filed: Sep. 10, 2020
(86) PCT No.: PCT/EP2020/075349

§ 371 Date: Mar. 10, 2022

(30) Foreign Application Priority Data
Sep. 12, 2019 (FR) FR1910100

(51) Int. Cl. G01N 21/952; G01B 11/30

(52) U.S. Cl. CPC G01N 21/952; G01B 11/303

(57) ABSTRACT

The invention relates to a device (1) for measuring the surface condition of a component (4, 5, 6). Said device (1) comprises a measurement member (2) comprising at least one sensor (21, 22, 23) capable of measuring at least one datum relating to the surface condition of the component (4, 5, 6) and at least one transmitter (24) capable of transmitting the datum from the sensor (21, 22, 23). The measurement device (1) also comprises a support (3) for the measurement member (2), the support comprising means for connecting same to the component (4, 5, 6).

The invention relates to the field of gas distribution pipes made of polymer material. More precisely, the invention relates to the welding of several junctions of these pipes.

Over 200 000 junctions are currently made every year on the national gas distribution network in France. Most of these junctions are made automatically using robots, according to technologies known in the state of the art, for example butt welding or electrofusion welding.

Patent FR 2 762 540 describes welding robots capable of operating automatically by integrating an electronic module which manages the various welding phases.

However, such robots and the methods implemented cannot guarantee junction welds that are both robust and durable throughout the lifetime of the pipe, since some of the steps could have a welding quality fault, in particular, at the first stage, caused by scraping and cleaning the components to be welded. The scraping and cleaning steps are required to eliminate a chemical barrier which prevents interdiffusion of the macromolecules. Such disadvantages generate high costs to detect leaks, as well as initial excavation costs. These costs are then followed by others, which are just as high, to repair the leaks when they have been identified.

In addition, the steps of measuring the surface conditions of the components to determine whether these components all have the necessary requirements for the welding step are operations that are complex to perform due to the environment in which they must be performed and generally require the use of several independent devices.

The invention aims in particular to simplify the steps of measuring the surface conditions of the components to be welded, thereby significantly reducing the costs relating to these steps. Thus, the surface condition of a component unsuitable for a good quality weld can be detected more effectively, which finally reduces poor welds and all the costs incurred by these poor welds throughout the lifetime of the pipe.

Thus, the invention relates to a device for measuring the surface condition of a component made of polymer material, this device comprising:
a measurement member comprising at least one sensor capable of measuring at least one datum relating to the surface condition of the component and at least one transmitter capable of transmitting the datum from the sensor, and
a support for the measurement member, the support comprising means for connecting same to the component.

Thus, the device of the invention can be used to supply one or more data relating to the surface condition of a component to a data acquisition unit, to perform in particular the step of producing a representation of the surface condition of the component.

These data relating to the surface condition of the component are measured using the sensor of the measurement member. To do this, the measurement member of the device of the invention may advantageously comprise an energy source to supply energy to the sensor and/or the transmitter. Preferably, this energy source may be wireless, for example a battery. A wireless energy source makes the device easier to use since it is no longer restricted by problems of wires being tangled up or the need for a fixed energy source located nearby.

Activation of the sensor and transmission of the measured data are managed by the electronic element of the measurement member. The data measured by the sensor are transferred to the data acquisition unit which processes them to produce the representation of the surface condition of the component concerned. The data acquisition unit then analyses this representation to obtain one or more parameters relating to the surface condition of the component and compares each parameter with at least one predetermined threshold value previously saved in the data acquisition unit.

To measure the data relating to the surface of the component, the measurement member can be displaced in translation and/or in rotation to scan this surface. Preferably, the measurement member can be displaced to scan the entire surface which will be welded, in order to measure data over this entire surface.

The pipe components to be assembled may correspond to any type of junction, that can be welded two at a time, known to those skilled in the art, provided that one of the two components is a tube. For example, these components may be tubes, sleeves or connection saddles. Thus, the predetermined roughness and cleanliness thresholds can be specific to one or more types of junction.

The polymer material used to make these pipe components may be any material known to those skilled in the art allowing these two components to be welded together in order to form a gas pipe network, in particular using butt or electrofusion welding technologies. Thermoplastic materials are suitable polymer materials. Polyethylene (PE) and polyolefins are especially suitable polymer materials.

Advantageously, a laser profilometry type sensor is used.

Thus, the step of producing the representation of the roughness of the component is implemented using a sensor which does not damage the component to be welded, which helps preserve an optimum surface condition of the portion of the component to be welded.

Advantageously, a UV fluorescence type sensor is used.

Thus, the step of producing the representation of the cleanliness of the component is implemented using a sensor which does not damage the component to be welded, which helps preserve an optimum surface condition of the portion of the component to be welded.

Advantageously, an infrared spectrometer type sensor is used.

Like the UV fluorescence type sensor, the step of producing the representation of the cleanliness of the component is implemented using a sensor which does not damage the component to be welded.

Advantageously, the support comprises a ferrule for connecting to the component.

Thus, the support can be positioned at least partially in a hollow pipe component in order to measure data relating to the outer surface of this component. Such a ferrule can be displaced in a longitudinal translational movement relative to the longitudinal axis of the component. This ferrule also allows a rotational movement of the measurement member about the longitudinal axis of the component. Combining these two movements allows a more complete scan of the surface to be welded of the component.

Advantageously, the support comprises a clamping frame around the component.

Thus, the measurement member can be positioned so that it can measure an inner surface of a component to be welded. The clamping frame is designed so that the measurement member can be displaced in a longitudinal translational movement and a rotational movement, both relative to the longitudinal axis of the component. Combining these two movements allows a more complete scan of the surface to be welded of the component.

Advantageously, the measurement member comprises an infrared thermometer.

Thus, a device which also overcomes the problems of measuring the temperature of the components prior to welding can be provided. The measurement member can therefore be used to measure the temperature of the component. This measurement is transmitted by the transmitter to the acquisition unit which processes it and thus determines the quantity of energy required for a weld.

Advantageously, the measurement device according to the invention comprises a wireless energy source configured to supply energy to the sensor and/or the transmitter.

The invention also relates to a control assembly comprising a device according to the invention and a data acquisition unit.

The invention also relates to a use of a control assembly according to the invention to implement a method for checking components made of polymer material prior to welding or to implement a method for welding components made of polymer material.

### BRIEF DESCRIPTION OF THE FIGURES

We will now describe several embodiments of the invention, as examples and referring to the attached drawings in which:

FIG. 1 is a diagram illustrating elements of a device for checking, prior to welding, a tube made of polymer material and an accessory made of polymer material according to a first embodiment and a second embodiment,

FIG. 2 is a diagram illustrating elements of a device for checking, prior to welding, a tube made of polymer material and an accessory made of polymer material according to a third embodiment and a fourth embodiment,

FIG. 3 is a flowchart showing various steps of the checking method according to a first embodiment,

FIG. 4 is a flowchart showing various steps of the method according to a second embodiment, and

FIG. 5 is a flowchart showing various steps of the welding method of the invention according to a first embodiment,

FIG. 6 is an example showing the surface condition of a component.

### DETAILED DESCRIPTION

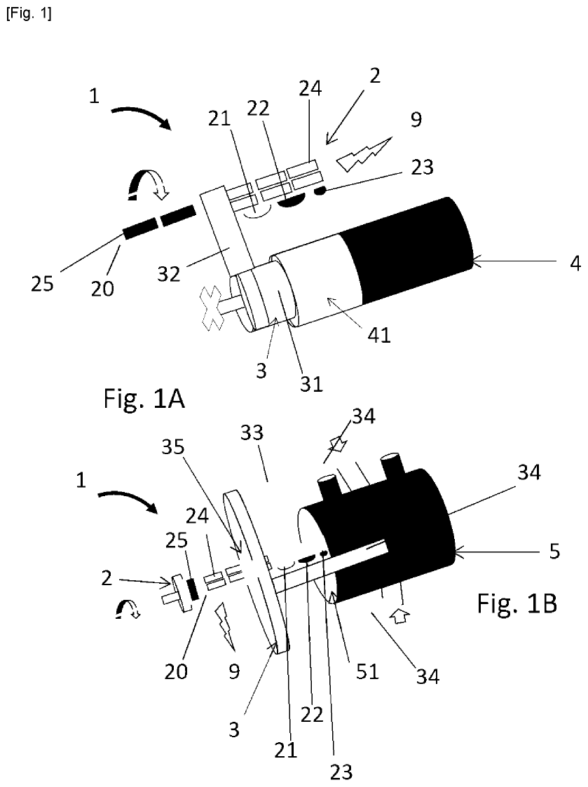

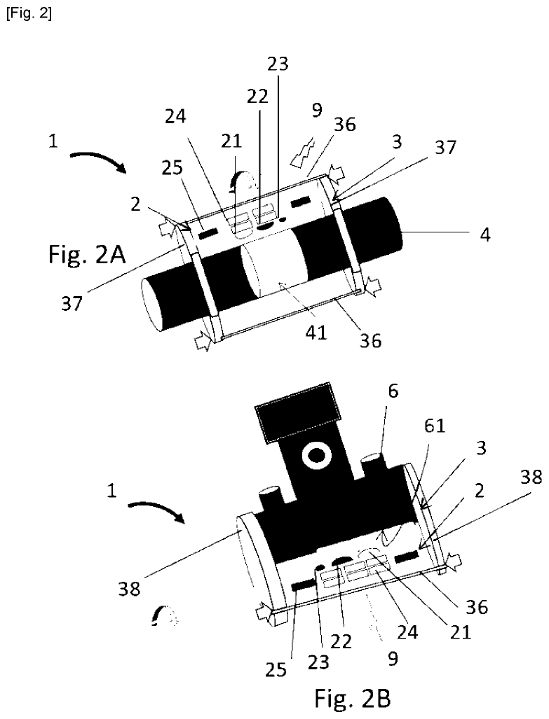

FIGS. 1A to 2B show elements of devices 1 for measuring the surface condition of a component 4, 5 or 6 made of polymer material, according to four different embodiments.

In all these different embodiments, the measurement device 1 comprises a measurement member 2 and a support 3 for the measurement member 2 comprising means for connecting to the component 4, 5 or 6. These components 4, 5 or 6 have a tubular, cylindrical, profiled shape of circular cross-section.

The measurement member 2 comprises a main body 20, a laser profilometry type sensor 21, a UV fluorescence type sensor 22, an infrared thermometer 23, transmitters 24 and at least one wireless energy source 25 which supplies energy to the four above-mentioned elements.

The main body 20 may consist of a strip in order to easily arrange the various elements of the measurement member 2.

As shown on FIG. 1A, the measurement device 1 can be used in particular to measure data relating to the surface condition (roughness, cleanliness and temperature) of an outer portion 41 of a hollow tube 4 whose end is intended to be welded in the half-socket of the sleeve 5 of FIG. 1B. The support 3 thus comprises a ferrule 31 adapted to be positioned in the tube 4 and an arm 32 which extends from the ferrule 31 and which can be used to offset the measurement member 2 relative to the portion 41 of the tube 4. To take the measurements, the main body 20 is adapted to be moved in translation relative to the tube 4, in a direction parallel to the longitudinal axis of the tube 4. The main body 20 is also adapted to be moved in rotation relative to the tube 4, about this longitudinal axis. Thus, the laser profilometry type sensor 21 and the UV fluorescence type sensor 22 can scan the entire portion 41 of the tube 4. These two sensors can be used to supply data relating to the surface condition (roughness and cleanliness) of the portion 41 of the tube 4. These data are transmitted to a data acquisition unit 9 by the transmitters 24. The data acquisition unit 9 is adapted to process and analyse the data it receives.

In order to check the surface condition of the inner portion 51 of the sleeve 5, the support 3 of the device 1 according to a second embodiment comprises a clamping frame 33. This clamping frame 33 comprises lugs 34 which each exert a compression force on the outer surface of the sleeve 5, thus maintaining the support 3 in a fixed position relative to the sleeve 5. The support 3 also comprises a central part 35 in which an opening (not shown) is formed. This opening can be used to position at least partially the measurement member 2 in the half-socket of the sleeve 5. Through this opening, the main body 20 of the measurement member 2 can be moved in translation relative to the sleeve 5, in a direction parallel to the longitudinal axis of the sleeve 5. Thus, the measurement member 2 can be inserted deeper inside the sleeve 5. The main body 20 can also be moved in rotation relative to the sleeve 5, about this longitudinal axis. This combination of longitudinal and rotational movements allows the laser profilometry type sensor 21 and the UV fluorescence type sensor 22 to scan the entire inner portion 51 of the sleeve 5. By measuring the inner surface condition of the sleeve 5, it is possible in particular to determine anomalies present on the heating mat (e.g. wires moved, cavities, etc.).

A third embodiment shown on FIG. 2A can be used to check the surface condition of a portion 41 of a tube 4, intended to be welded with a portion (not shown) of a connection saddle 6.

To do this, the support 3 comprises two hoops 37 forming circular housings and adapted to encircle the tube 4. These two hoops 37 are connected to each other by means of two clamping rods 36 used to hold the entire support 3 and attach it to the tube 4. The two circular housings 37 each have an opening (not shown) used to place the measurement member 2 in an offset position relative to the portion 41 of the tube 4 and opposite this portion. Like the first two embodiments described, the main body 20 of the measurement member 2 can be moved in translation and in rotation so that the laser profilometry type sensor 21 and the UV fluorescence type sensor 22 can scan the entire portion 41 of the tube 4.

The connection saddle 6 intended to be welded with the tube 4 shown on FIG. 2B is a hollow component of semi-cylindrical shape. In order to check the surface condition of the inner portion 61 of the connection saddle 6, the support 3 of the checking device 1 according to the fourth embodiment comprises two contact elements 38. These contact elements 38 are adapted to be positioned each on one of the ends of the connection saddle 6. They are connected to each other by means of a clamping rod 36 used to attach the entire support 3 and hold it in a fixed position relative to the connection saddle 6. The two contact elements 38 each have an opening (not shown) used to place the measurement member 2 in an offset position relative to the inner surface of the connection saddle 6. As for the preceding embodiments, the main body 20 of the measurement member 2 can be moved in translation and in rotation so that the laser profilometry type sensor 21 and the UV fluorescence type sensor 22 can scan the entire portion to be welded of the connection saddle 6. By measuring the inner surface condition of the connection saddle 6, it is possible in particular to determine anomalies present on the heating mat (e.g. wires moved, cavities, etc.).

In addition, the device 1 can be associated with automated means to implement a method for checking the components 4, 5, 6 prior to welding. These automated means include the data acquisition unit 9, which forms with the measurement device the control assembly of the invention, to which the data measured by the various sensors 21, 22, 23 of the device 1 are transmitted. The measurement device 1 can be a robot allowing automated implementation of the checking method.

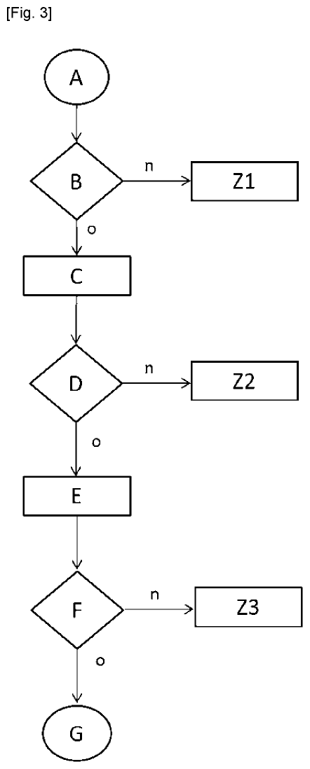

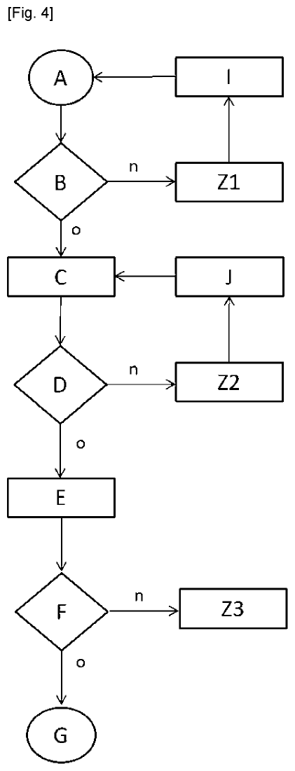

FIGS. 3 and 4 show two embodiments of a method for checking, prior to welding, a tube 4 made of polymer material and an accessory 5 or 6 made of polymer material.

The checking method according to the first embodiment (FIG. 3) starts with a first step A of determining the respective values relating to the roughness of the tube 4 and of the accessory 5 or 6 to be welded, in this case to form a gas pipe. Such a method is also adapted for checking, prior to welding, a pipe intended to receive substances other than gas and whose transport is compatible with the polymer material of the tube 4 and of the accessory 5 or 6. Such a substance may be for example a fluid, such as water.

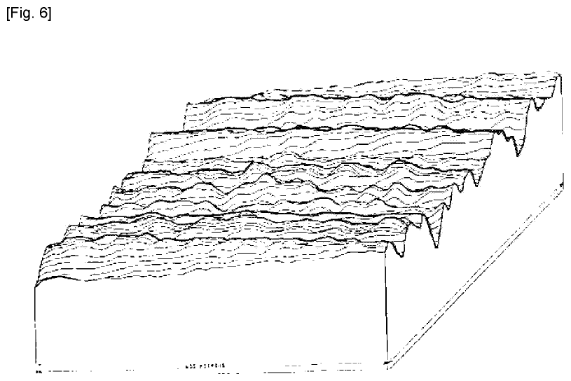

In the embodiment shown on FIG. 3, the step A comprises producing a representation of the roughness of the tube 4 and of the accessory 5 or 6. This production step is implemented using one or more laser profilometry type sensors 21 of the device 1 taking data measurements relating to the roughness of the tube 4 and of the accessory 5 or 6 to be welded. The measured data are then processed by computer via a data acquisition unit 9 integrated in the automated means, in order to produce said representation, of which a 3D graphical representation example is shown on FIG. 6.

After producing the representation of the roughness of the tube 4 and of the accessory 5 or 6, the roughness is analysed to determine the respective values relating to the roughness of the tube 4 and of the accessory 5 or 6. Such values may be taken from the following non-exhaustive list: the total roughness (Rt), the mean deviation (Ra), the mean roughness, the maximum peak (Rp), the maximum trough (Rc), the period of the main groove, the developed area of the portion of the component to be welded, the structure anisotropy, the striation in the scraping direction.

This first step A is followed by a comparison step B during which the respective values relating to the roughness of the tube 4 and of the accessory 5 or 6 are compared respectively with a roughness threshold of the tube 4 and a roughness threshold of the accessory. This can be used to determine if a predetermined condition between the value relating to the roughness of the tube 4 and a roughness threshold of the tube 4 and if a predetermined condition between the value relating to the roughness of the accessory 5 or 6 and a roughness threshold of the accessory 5 or 6 are met. If they are met, the transition to step C is authorised. However, if at least one of the two conditions of step B is not met, then these automated means prevent the transition to step C (step Z1). An operator cannot manually bypass blocking of the method by the automated means. The automated means may comprise a tablet, a computer or a smartphone containing software programmed to prevent the transition to step C if one of the predetermined conditions required to validate this transition is not met. The automated means may be, for example, programmed to authorise unblocking of the means required to perform step C only if the predetermined conditions of step B are both met.

Step C is a step of determining respective values relating to the cleanliness of the tube 4 and of the accessory 5 or 6.

According to this first embodiment, step C comprises a step of producing a representation of the cleanliness of the tube 4 and of the accessory. Such a step can be implemented using one or more UV fluorescence type sensors 22 of the device 1 taking data measurements relating to the cleanliness of the surface of the tube 4 and of the accessory 5 or 6 to be welded. As a replacement for or in addition to the UV fluorescence type sensors 22, the device 1 may also comprise one or more infrared spectrometers which can also be used to measure data relating to the cleanliness of the surface of the tube 4 and of the accessory 5 or 6 to be welded. The measured data are then processed by computer via the data acquisition unit 9, in order to produce said representation.

After producing the representation of the cleanliness of the tube 4 and of the accessory 5 or 6, the cleanliness is analysed to determine the respective values relating to the cleanliness of the tube 4 and of the accessory 5 or 6. Such values may relate to the degree of pollution of the surface condition, such as the quantity of grease or the quantity of dust.

Step C is followed by a comparison step D during which the respective values relating to the cleanliness of the tube 4 and of the accessory 5 or 6 are compared respectively with a cleanliness threshold of the tube 4 and a cleanliness threshold of the accessory 5 or 6. This can be used to check if a predetermined condition between the value relating to the cleanliness of the tube 4 and a cleanliness threshold of the tube 4 and if a predetermined condition between the value relating to the cleanliness of the accessory 5 or 6 and a cleanliness threshold of the accessory 5 or 6 are met. If they are met, the transition to step E of measuring values relating to the temperature of the tube 4 and of the accessory 5 or 6 is authorised by the automated means. Such a temperature measurement is taken using the infrared thermometer 23 of the measurement member 2 of the device 1.

However, if at least one of the two conditions of step D is not met, then the automated means prevent the transition to step E (step Z2). Once again, a manual operator cannot bypass blocking of the method by the automated means. At this stage of the method, blocking of the method can be carried out in different ways. For example, the automated means can prevent unblocking of the means of the device 1 in order to measure the temperature of the tube 4 and of the accessory 5 or 6. Thus, this blocking by the automated means cannot be bypassed.

Step E is followed by a comparison step F during which the respective values relating to the temperature of the tube 4 and of the accessory 5 or 6 are compared with a temperature range. If the measured values relating to the temperature of the tube 4 and of the accessory 5 or 6 are located outside the temperature range, the automated means prevent the transition to step F of assembling the accessory 5 or 6 on the tube 4 (step Z3). Inversely, if these values relating to the temperature are located within the temperature range, the transition to step G of assembling the accessory 5 or 6 on the tube 4 is authorised by the automated means and the operator assembles the accessory 5 or 6 on the tube 4 using the assembly means (not shown) of the checking device 1.

When all the predetermined conditions of steps B, D and F are met and assembly step G has been performed using assembly means (not shown) or manually, the checking method according to this first embodiment is finished and the tube 4 and the accessory 5 or 6 can be welded together.

The method according to the second embodiment shares the steps of the method according to the first embodiment. It further comprises a step I of scraping a portion not previously scraped of the tube 4 and/or of replacing the accessory 5 or 6 which are implemented when the automated means have prevented the transition to step C (step Z1). The alternative of step I according to which the tube 4 is scraped on a portion not previously scraped is implemented if the predetermined condition between the value relating to the roughness of the tube 4 and a roughness threshold of the tube 4 is not met. Step A is then repeated to determine if the roughness of the newly scraped portion of the tube 4 meets the necessary requirements regarding scraping to produce a high-quality and durable weld. If this is still not the case, the automated means once again prevent the transition to step C (step Z1) and the checking loop is repeated. It is therefore possible to efficiently guarantee that the roughness of the tube 4 is suitable for a high-quality weld, without having to replace the tube 4, which is a complex and expensive operation.

The alternative of step I according to which the accessory 5 or 6 is replaced is implemented if the predetermined condition between the value relating to the roughness of the accessory 5 or 6 and a roughness threshold of the accessory 5 or 6 is not met. In this case, the accessory 5 or 6 is replaced and steps A and B are repeated. As previously, if this condition is still not met during the new step B, the automated means once again prevent the transition to step C (step Z1) and the checking loop is repeated.

The method according to the second embodiment also comprises a second checking loop comprising steps C, D Z2 and J. When the automated means block the transition to step E, a step J is in fact implemented. Step J comprises cleaning the surface of the tube 4 and/or of the accessory 5 or 6 depending on the predetermined condition of step D which is not met. Like the first checking loop, step C is implemented again at the end of step J, then the comparison step D is implemented. If at least one of the predetermined conditions is still not met, the automated means block the transition to step E of measuring values relating to the temperature of the tube 4 and of the accessory 5, 6 and the second checking loop is implemented again.

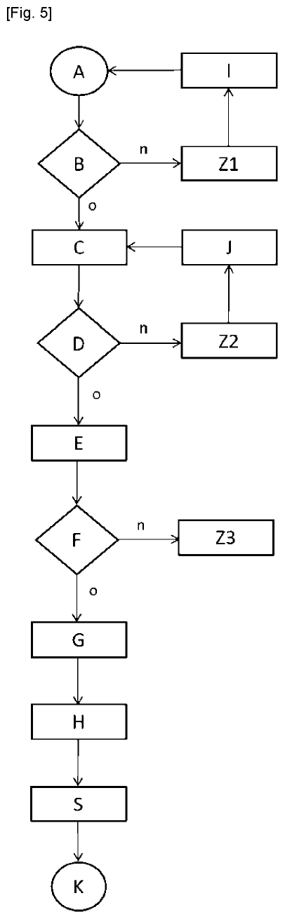

FIG. 5 shows an embodiment of a method for welding a tube 4 made of polymer material and an accessory 5 or 6 made of polymer material to form a gas pipe, wherein the checking method according to the second embodiment described previously is implemented.

This welding method includes all the steps mentioned in the description of the checking method according to the second embodiment.

In a variant, not shown, of the welding method of the invention, a third checking loop is performed between steps E, F and Z3. More precisely, a second measuring step E is implemented after step Z3 to determine a new measurement relating to the temperature of the tube 4 and of the accessory 5 or 6. This second measurement step is performed using the infrared thermometer 23 of the measurement member 2 of the device 1 and is implemented after a certain period of time, to allow the temperature of the tube 4 and of the accessory 5 or 6 to reach ambient temperature. Step F is then implemented again and if one of the second measured values relating to the temperature of the tube 4 and of the accessory 5 or 6 is still located outside the temperature range, the automated means once again prevent the transition to step G. In addition, if one of the measured values relating to the measured temperature of the tube 4 and of the accessory 5 or 6 is too far from one of the limits of the temperature range, preventing the tube 4 or the accessory 5 or 6 from reaching an acceptable temperature for a welding step, the method can be stopped by the automated means.

When the result of step F of comparing the measured values relating to the temperature measured in step E is positive, in other words these measured values lie within the temperature range, the automated means allow the transition to step G of the method.

In step H, the quantity of energy to be supplied to the welding robot to weld together the tube 4 and the accessory 5 or 6 is determined, depending on the temperature values measured in step E. Depending on these measured temperature values, the time and the heating power are adapted by the robot to guarantee a durable assembly. This assembly is produced during the implementation of the welding step S.

After performing the welding step (step S), a step of producing a report (step K) is performed to issue a welding and traceability report for the welded components in order to record the two welded components and the welding conditions.

The welding method of the invention may also comprise steps of scraping the tube 4 prior to step A. These prior scraping steps are performed to prepare the surface of the tube 4 for the welding step in view of the scraping requirements of the tube 4. This method may also comprise steps of cleaning the tube 4 and the accessory 5 or 6 prior to step C. These prior cleaning steps are performed to prepare the surface of these components for the welding step in view of the cleanliness requirements of each of these components.

The automated means of the measurement device are designed to assist the operator when implementing one, at least, of the methods described above. They are programmed in particular to allow the transition to a particular next step as indicated or, on the contrary, to prevent this transition if the predetermined condition is not met. These means could control all or some of the steps of the methods. The device therefore comprises a computer program on a storage medium comprising code instructions that can control these steps when it is executed on the device.

Steps G and H of the embodiment of the welding method of FIG. 5 can be implemented in the opposite order to that described previously. These two steps can also be implemented simultaneously.

### LIST OF REFERENCES

1: measurement device
2: measurement member
3: support for the measurement member
4: tube made of polymer material
5: sleeve made of polymer material
6: connection saddle made of polymer material
9: data acquisition unit
20: main body
21: laser profilometry type sensor
22: UV fluorescence type sensor
23: infrared thermometer
24: transmitter
25: energy source
31: ferrule
32: arm
33: clamping frame
34: clamping lugs
35: central part
36: clamping rod
37: hoop
38: contact element
41: portion of the tube surface to be welded
51: portion of the sleeve surface to be welded
61: portion of the saddle surface to be welded
step A: determining respective values relating to the roughness of the tube and of the accessory
step B: comparing the roughness of the tube and of the accessory
step C: determining respective values relating to the cleanliness of the tube and of the accessory
step D: comparing the cleanliness of the tube and of the accessory
step E: measuring respective values relating to the temperature of the tube and of the accessory
step F: comparing the values relating to the temperature of the tube and of the accessory
step G: assembling the accessory on the tube
step H: determining a quantity of energy required for the weld
step I: scraping a portion not previously scraped of the tube and/or replacing the accessory
step J: cleaning the surface of the tube and/or of the accessory
step K: issuing a welding and traceability report
step S: welding
step Z1, Z2, Z3: blocking of the method by the automated means

1. Device for measuring the surface condition of a component made of polymer material, characterised in that it comprises:
a measurement member comprising at least one sensor capable of measuring at least one datum relating to the surface condition of the component and at least one transmitter capable of transmitting the datum from the sensor, and
a support for the measurement member, the support comprising means for connecting same to the component.

2. Device according to claim 1, wherein the sensor is selected from the list consisting of: laser profilometry type sensor, UV fluorescence type sensor and infrared spectrometer type sensor.

3. Device according to claim 1, wherein a first sensor is a laser profilometry type sensor and a second sensor is a UV fluorescence type sensor.

4. Device according to claim 1, wherein a first sensor is a laser profilometry type sensor and a second sensor is an infrared spectrometer type sensor.

5. Device according to claim 1, wherein the support comprises a ferrule for connecting to the component.

6. Device according to claim 1, wherein the support comprises a clamping frame around said component.

7. Device according to claim 1, wherein the measurement member comprises an infrared thermometer.

8. Device according to claim 1, comprising a wireless energy source configured to supply energy to the sensor and/or the transmitter.

9. Control assembly comprising a measurement device according to claim 1 and a data acquisition unit.

10. Use of a control assembly according to claim 9, to implement a method for checking components made of polymer material prior to welding or to implement a method for welding components made of polymer material.
